(19) United States
(12) Patent Application Publication
(10) Pub. No.: US 2009/0178928 A1
(43) Pub. Date: Jul. 16, 2009

(54) Process for Desalting Glycerol Solutions and Recovery of Chemicals

(75) Inventors: Jeremie Ray GROOS, Hamburg (DE); Ahmad K. Hilaly, Forsyth, IL (US); Krishnamurthy Mani, Basking Ridge, NJ (US); Rishi Shukla, Indianapolis, IN (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Archer-Daniels-Midland Company, Decatur, IL (US)

(21) Appl. No.: 12/165,384

(22) Filed: Jun. 30, 2008

Related U.S. Application Data
(60) Provisional application No. 60/929,513, filed on Jun. 29, 2007.

(51) Int. Cl. B01D 61/44; B01D 61/46

(52) U.S. Cl. 204/541; 554/124; 204/630

(57) ABSTRACT

Processes for desalting glycerol-rich solutions or process streams using electrodialysis are provided. The glycerol-rich process streams are typically byproducts from the production of biodiesel. Following electrodialysis, the resulting aqueous salt solution is placed in a water splitting cell to recover the acid and base components of the salt. These acid and base components, in turn, can be reused in other processes, such as biodiesel production.

### BACKGROUND OF THE INVENTION

1. Field of the Invention

This invention relates to a process for recovering acids and bases from mixtures containing glycerol using water splitting electrodialysis membranes. The recovered acids and bases are suitable for use as neutralization agents or catalysts.

2. Background Art

Glycerin or glycerol is a polyhydric alcohol produced via a number of processes. For example, glycerol (glycerin or glycerine) is produced as a by-product in the manufacture of biodiesel, fatty acid methyl esters, soap, and fatty acids. Dwindling supplies of oil have made biodiesel a viable alternative to petroleum-based fuel because biodiesel can be manufactured from renewable feedstock sources such as soybeans or vegetable oils.

Biodiesel contains alcohol esters of lipids, mainly mono alkyl esters such as methyl esters. Acylglycerols are the main constituent of all natural oils and fats and comprise triacylglycerols, diacylglycerols, and monoacylglycerols. The production of biodiesel entails the transesterification (alcoholysis) of feedstock with an alcohol, typically methanol.

In the synthesis of alcohol esters of lipids, a homogeneous catalyst, such as sodium hydroxide (NaOH) or sodium methoxide (NaOMe), is often combined with an oil feedstock and an alcohol; the ester synthesis reaction proceeds easily. As the transesterification proceeds, fatty acids esterified to glycerol in the fat or oil feedstock are subjected to alcoholysis by methanol, so the fatty acid is transferred from the glycerol to the methanol. Glycerol accumulates in the reaction mixture and sinks to form a separate, water-miscible, glycerol-rich phase (or process stream). Alternatively, esters can be synthesized from alcohols and free fatty acids. A homogeneous catalyst, such as hydrochloric acid or sulfuric acid, is combined with a free fatty acid feedstock, such as soy fatty acids, and an alcohol, such as methanol; the ester synthesis reaction proceeds easily. By withdrawing water created in the ester synthesis reaction, high yields of ester can be obtained.

Transesterification produces both a glycerol-rich phase (or process stream) and a biodiesel-rich phase (or process stream). The glycerol-rich process stream is separated from the biodiesel process stream. In addition to glycerol, the glycerol-rich process stream often comprises methanol (a volatile component), water, residual catalyst and a small amount of fatty acid salts or soaps that were present in the starting material or unintentionally produced in the transesterification reaction. When alkali catalysts are used, the fatty acids in the glycerol-rich process stream are present as salts or soaps of residual alkali catalyst. These soaps are difficult to remove from the glycerol-rich process stream. Consequently, an acid, such as hydrochloric acid (HCl), can be added to the glycerol-rich process stream to dissociate (neutralize) the fatty acid soaps or fatty acid salts into cations, salts and free fatty acids. The residual alkali catalyst (base catalyst) is rendered ineffective as a catalyst by neutralization with acid, and fresh base catalyst must continually be added to the process. Thus, manufacturing facilities must purchase and store adequate quantities of alkali, often in a concentrated form. Such storage facilities must be properly equipped with safety provisions, such as dams surrounding the primary storage vessels. Alkali catalysts are often sold, stored, and transported as highly concentrated solutions; the high concentrations render the catalysts very toxic and reactive. In addition, the highly reactive catalyst must be transported within the manufacturing facility, placing personnel to at risk of exposure to toxic chemicals. In the case of a common base catalyst, Sodium hydroxide, accidental exposure may cause very serious injuries and even death.

In addition, fresh acid for neutralization must be continuously purchased, stored and transported. Like alkali compounds, acids are often sold, stored, and transported as highly concentrated solutions; the high concentrations render the acids very toxic and reactive. In addition, the highly reactive acid must be transported within the manufacturing facility, placing equipment and personnel at risk of exposure to toxic chemicals. In the case of a common acid, hydrochloric acid, accidental exposure may cause very serious injuries and even death.

The free fatty acids are less dense than the remainder of the glycerol-rich process stream, and rise to the surface of the glycerol-rich process stream, where they are recovered by decantation. In an embodiment, the resulting defatted glycerol-rich process stream comprises glycerol (CH₂OH:CHOH:CH₂OH), methanol (CH₃OH, a volatile component), water, certain organic contaminant byproducts, and salt, such as sodium chloride (NaCl). The defatted glycerol-rich process stream must be further purified to obtain a commercially marketable product.

The defatted glycerol-rich process stream may be subjected to distillation to remove the volatile component (methanol and/or water) to obtain a “crude glycerol” process stream comprising approximately 95% glycerol, the remainder comprising salt. The crude glycerol is often purified by distilling the glycerol away from the remaining salt via vacuum distillation to obtain a purified glycerol product, such as USP (United States Pharmacopeia) Grade glycerol. The process suffers from operational difficulties due to the ongoing deposition of salt on the evaporator surfaces, resulting in yield losses, and requires frequent process interruptions for cleaning inside the evaporator. Disposal of the resulting salt waste in landfills entails additional cost and potential long-term environmental liabilities.

Salt has been removed from crude glycerol process streams by electrodialysis (Schaffner et al., Filtration & Separation December 2003 pp 35-39). However, such processes result in the loss of unacceptable amounts (2-7%) of glycerol across the membranes. Disposal of the resulting glycerol-laden waste salt solutions can also be a problem both in terms of expense and environmental impact.

There is, therefore, a need for an improved process that reduces or eliminates the salt contaminant in the crude glycerol process stream with little or no loss of glycerol and without producing a waste salt solution.

### BRIEF SUMMARY OF THE INVENTION

The present invention provides a process for treating a glycerol solution containing fatty acid soaps comprising acidifying the glycerol solution with an acid to produce free fatty acids and salt; removing the free fatty acids from the glycerol solution; separating an aqueous salt solution from the glycerol solution by electrodialysis; and, electrolytically splitting the salt component of the aqueous salt solution in a water splitting cell, thus producing a depleted salt solution, a recovered acid solution and a recovered base solution.

The present disclosure provides a process for recovering and reusing a base catalyst and a neutralizing acid in biodiesel production, comprising transesterifying oil feedstock with at least one alcohol using a base catalyst, thus producing a biodiesel process stream and a glycerol-rich process stream comprising a fatty acid soap; neutralizing the glycerol-rich process stream with an acid to form a salt, thus producing free fatty acids and a defatted glycerol-rich process stream containing the salt; electrodialyzing the defatted glycerol-rich process stream, thus separating an aqueous solution comprising the salt from the defatted glycerol-rich process stream; splitting the salt into component acid and base in a water splitting cell, producing a recovered acid and a recovered base; and, introducing the base in the transesterification of oil feedstock and contacting the acid with a glycerol-rich process stream.

The present disclosure also provides a process for desalting a glycerol solution containing fatty acid soaps and salt and converting the salt to the salt's acid and base components, comprising acidifying the glycerol solution with an acid to produce insoluble free fatty acids; removing the insoluble free fatty acids from the glycerol solution; separating an aqueous salt solution from the glycerol solution by placing the glycerol solution in an electrodialysis cell; and electrolytically splitting the salt component of the aqueous salt solution in a water splitting cell, thus producing a depleted salt solution, a recovered acid solution and a recovered base solution.

The present disclosure also provides a process for producing esters comprising producing an ester-rich phase and a glycerol-rich phase comprising fatty acid soaps by combining an oil feedstock, an alcohol, and a homogeneous catalyst; separating the ester-rich phase from the glycerol-rich phase; and converting the fatty acid soaps to free fatty acids by contacting the glycerol-rich phase with a recovered acid solution.

A further embodiment of the present disclosure is a process for producing esters, comprising combining an oil feedstock, an alcohol, and a homogeneous catalyst selected from a recovered acid solution, a recovered dewatered acid catalyst, a recovered base catalyst and combinations of any thereof.

The disclosure also provides a biodiesel apparatus, comprising a biodiesel reactor; at least one electrodialysis apparatus fluidly connected to the biodiesel reactor; and at least one water splitting cell fluidly connected to the at least one electrodialysis apparatus, the biodiesel reactor, or both.

The disclosure also provides a process for recovering and reusing a neutralizing acid in biodiesel production, comprising transesterifying oil feedstock with at least one alcohol using a base catalyst, thus producing a biodiesel process stream and a glycerol-rich process stream comprising a fatty acid soap; neutralizing the glycerol-rich process stream with an acid to generate a salt; removing free fatty acid from the neutralized glycerol-rich process stream, thus producing a defatted glycerol-rich process stream containing the salt; subjecting the defatted glycerol-rich process stream to electrodialysis, thus separating an aqueous solution comprising the salt from the glycerol-rich process stream; electrolytically splitting the salt in the aqueous solution in a water splitting cell, thus converting the salt to the salt's acid and base components; recovering the acid component; and, reusing the acid component to neutralize a glycerol-rich process stream.

The disclosure also provides a process for removing lipids from a solution by contacting the solution with a coalescer membrane.

### BRIEF DESCRIPTION OF THE DRAWINGS/FIGURES

FIG. 1 is a flow chart depicting an embodiment of the present disclosure.

FIG. 2 is a flow chart depicting an embodiment of the process of the present disclosure.

FIG. 3 is a schematic diagram of an example of an electrodialysis cell.

FIG. 4 is a schematic diagram of an example of a water-splitting cell.

FIG. 5 is a schematic diagram of an embodiment of a biodiesel apparatus according to the present disclosure.

### DETAILED DESCRIPTION OF THE INVENTION

### Definitions

As used herein, the term “base catalyst” refers to a base that catalyzes a transesterification reaction of oil feedstock with at least one alcohol to produce biodiesel. Suitable base catalysts include but are not limited to sodium hydroxide (NaOH) and potassium hydroxide (KOH).

As used herein, the term “neutralizing acid” refers to an acid that causes dissociation of a fatty acid soap to produce free fatty acids. The acidification or neutralization reaction is one in which an acid and a fatty acid soap containing a base or alkali (soluble base) react and produce a free fatty acid and a salt. An example of neutralization is illustrated below. A fatty acid soap is converted from a sodium salt (the soap) to a fatty acid by the following reaction (Scheme 1) with hydrochloric acid to produce salt and a free fatty acid which is insoluble or poorly soluble in a polar solvent.

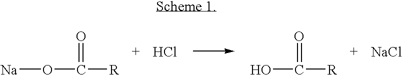

In the present disclosure, the neutralization a reaction can take place in glycerol. Suitable neutralizing acids include, but are not limited to, hydrochloric acid and sulfuric acid.

As used herein, the term “biodiesel” refers to a solution of alcohol esters of lipids produced in a transesterification reaction. For example, biodiesel can be produced by reacting feedstock with an alcohol, such as methanol to produce methyl esters. Feedstock includes virtually any fats/oils of vegetable or animal origin. Examples of feedstock include but are not limited to butterfat, cocoa butter, cocoa butter substitutes, illipe fat, kokum butter, milk fat, mowrah fat, phulwara butter, sal fat, shea fat, borneo tallow, lard, lanolin, beef tallow, mutton tallow, tallow, animal fat, camelina oil, canola oil, castor oil, coconut oil, coriander oil, corn oil, cottonseed oil, hazelnut oil, hempseed oil, jatropha oil, linseed oil, mango kernel oil, meadowfoam oil, mustard oil, neat's foot oil, olive oil, palm oil, palm kernel oil, peanut oil, rapeseed oil, rice bran oil, safflower oil, sasanqua oil, shea butter, soybean oil, sunflower seed oil, tall oil, tsubaki oil, tung oil, vegetable oils, marine oils, menhaden oil, candlefish oil, cod-liver oil, orange roughy oil, pile herd oil, sardine oil, whale oils, herring oils, triacylglycerols, diacylglycerols, monoacylglycerols, triolein palm olein, palm stearin, palm kernel olein, palm kernel stearin, triglycerides of medium chain fatty acids, and derivatives, conjugated derivatives, genetically-modified derivatives and mixtures of any thereof.

Other feedstocks include used cooking oils, float grease from wastewater treatment plants, animal fats such as beef tallow and pork lard, crude oils, “yellow grease,” i.e., animal or vegetable oils and fats that have been used or generated as a result of the preparation of food by a restaurant or other food establishment that prepares or cooks food for human consumption with a free fatty acid content of less than 15%, and white grease, i.e., rendered fat derived primarily from pork, and/or other animal fats, which has a maximum free fatty acid content of 4%.

As used herein, the term “transesterifying” refers to the reaction of a feedstock and a C₁-C₆ alcohol in the presence of an alkaline catalyst. This reaction is typically followed by separating the glycerol-rich soap stock, removing the catalyst residue and stripping off the lower alcohols. Transesterification may be carried out with a suitable alcohol such as ethanol, isopropanol, butanol, or trimethylolpropane, but especially with methanol in the presence of a transesterification catalyst, e.g., metal alcoholates, metal hydrides, metal carbonates, metal acetates or various acids, especially with sodium alkoxide or hydroxide or potassium hydroxide. This process is discussed in more detail in, for example, U.S. Pat. No. 5,354,878, which is incorporated by reference.

As used herein, the term “biodiesel process stream” refers to a solution containing biodiesel produced from a transesterification reaction. A biodiesel process stream may contain greater than or equal to 95% biodiesel.

The term “glycerol-rich process stream,” as used herein, is a solution containing glycerol that is the byproduct of a transesterification reaction producing biodiesel. In an embodiment, the glycerol-rich process stream also contains contaminants, including fatty acid soaps. In an embodiment, a glycerol-rich process stream contains about 20-80% by weight glycerol, and in an embodiment, contains about 40-75% by weight glycerol.

As used herein, the term “defatted glycerol-rich process stream” refers to the glycerol-rich process stream substantially free of fatty acid soaps (e.g., contains less than about 10% fatty acid soaps).

The term “salt,” as used herein, refers to an alkali metal salt. Such salts include, but are not limited to NaCl, KCl, Na₂SO₄ and K₂SO₄.

As used herein, the term “decolorizing resin” refers to a substance that removes color bodies and other organic impurities from a solution that may be contacted with it. In terms of the present disclosure, the decolorizing resin removes such impurities from a glycerol-rich process stream or the defatted glycerol-rich process stream may be contacted with it. A suitable decolorizing resin includes an ion exchange resin. Suitable decolorizing resins include, but are not limited to, Optipore SD-2 (available from Dow Chemical Company, Midland, Mich.) or Mitsubishi DCA11 (available from Itochu Resins, New York, N.Y.).

As used herein, the term “chelating resin” refers to a substance that removes impurities, such as calcium and magnesium, from an aqueous solution that is contacted with it. A suitable chelating resin may be Amberlyst IRC-747 (available from Rohm and Haas Philadelphia, Pa.).

The term “electrodialysis,” as used herein, refers to an electromembrane process in which ions are transported through ion permeable membranes from one solution to another under the influence of a potential gradient. The electrical charges on the ions allow them to be driven through the membranes fabricated from, for example, ion exchange polymers. Applying a voltage between two end electrodes generates the potential field required for this. Since the membranes used in electrodialysis have the ability to selectively transport ions having positive or negative charge and reject ions of the opposite charge, useful concentration, removal, or separation of electrolytes can be achieved by electrodialysis. In an embodiment of the present disclosure, a glycerol solution containing a salt may be subjected to electrodialysis to remove the salt, producing a glycerol solution substantially free of salt and a salt-containing aqueous solution.

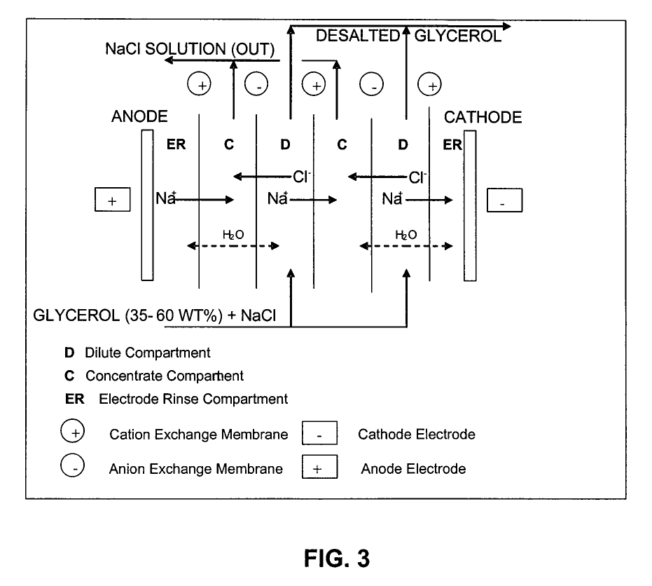

As used herein, the term “water splitting cell” refers to an apparatus where the anions and cations from salt in an aqueous solution combines with cations and anions from water to form an acid (originating from the anion of the salt) and a base (originating from the cation of the salt). An exemplary water splitting cell is depicted in FIG. 3. Bipolar membranes are often used in water splitting cells. Bipolar membranes consist of an anion-permeable membrane and a cation permeable membrane laminated together. When this composite structure may be oriented such that the cation-exchange layer faces the cathode it is possible, by imposing a potential field across the membrane, to split water into proton and hydroxyl ions. This results in the production of acidic and basic solutions at the surfaces of the bipolar membranes. Multiple bipolar membranes along with other ion permeable membranes can be placed between a single pair of electrodes in an electrodialysis stack for the production of acid and base from a neutral salt.

The term “fatty acid,” as used herein, refers to a carboxylic acid with a long aliphatic tail (chain), which may be either saturated or unsaturated. In an embodiment, the fatty acid has between 8 and 24 carbons. For example, the fatty acids can be derived from natural fats and oils. Examples of natural fats and oils that provide suitable fatty acids include but are not limited to soybean oil, coconut oil, corn oil, cotton oil, flax oil, mustard oil, palm oil, jatropha oil, rapeseed/canola oil, safflower oil, sunflower oil and mixtures thereof. Other sources of suitable fatty acids include used cooking oils, float grease from wastewater treatment plants, animal fats such as beef tallow and pork lard, crude oils, “yellow grease,” i.e., animal or vegetable oils and fats that have been used or generated as a result of the preparation of food by a restaurant or other food establishment that prepares or cooks food for human consumption with a free fatty acid content of less than 15%, and white grease, i.e., rendered fat derived primarily from pork, and/or other animal fats, which has a maximum free fatty acid content of 4%. The described process can be used to accelerate all acid or base neutralizations or reactions of two or more immiscible phases.

As used herein, a “fatty acid soap” is a soluble salt of a fatty acid. The fatty acid soap of the present disclosure can contain any cation that will render the fatty acid soap stock soluble in a polar solvent, such as water or glycerol. Such cations include but are not limited to such as sodium and potassium.

As used herein the term “homogenous catalyst” refers to a catalyst that is present in the same phase as the reactants, e.g., liquid reactants and liquid catalyst.

As used herein, “fluidly connected” means that a structure having at least two chambers has a passageway connecting the two chambers. The two chambers are fluidly connected if an intermediate chamber is fluidly connected to each of those two chambers. In other words, a system that is fluidly connected is capable of having fluid transfer from one part of the system to another.

The term “coalescer membrane” as used herein, refers to a hydrophobic polymer filtration membrane.

The present disclosure provides significant advantages over prior biodiesel manufacturing methods. Biodiesel is typically produced in a transesterification reaction between an animal or vegetable oil and an alcohol in the presence of a catalyst. Along with biodiesel, a glycerol solution containing salt and fatty acid soap is produced as a byproduct. In prior biodiesel production processes, the glycerol solution was lost, or the salt was removed from the glycerol solution, resulting in a salt-containing aqueous solution requiring disposal, creating additional expense. Moreover, prior processes of removing salt from glycerol usually resulted in unacceptable losses of glycerol.

In the present disclosure, crude glycerol process streams produced from biodiesel production are desalted with little or no loss of glycerol using an integrated electrodialysis water splitting process. In embodiments, the processes of the present invention, e.g., subjecting a glycerol-rich process stream to electrodialysis followed by water splitting of the resulting aqueous salt solution results in no overall loss of glycerol, i.e., all of the glycerol resulting from the biodiesel transesterification reaction is recovered. In embodiments, no more than about 0.5% to about 3.0% of glycerol is lost in the processes of the invention. In further embodiments, no more than about 1.5% to 2.5% of glycerol is lost in the methods of the present invention.

Moreover, waste salts are converted to constituent acid and base components. In an embodiment, the acid and base components are recycled to the biodiesel process for reuse as neutralizing agent and catalyst. In additional embodiments, the acid and base components can be used in other reactions, for example, sodium hydroxide can be used as a feedstock for the production of sodium methoxide or sodium ethoxide. The present disclosure therefore provides a biodiesel method that produces little waste compared to prior methods.

In embodiments, the present invention provides a process for treating a glycerol solution containing fatty acid soaps comprising acidifying the glycerol solution with an acid to produce free fatty acids and salt; removing the free fatty acids from the glycerol solution; separating an aqueous salt solution from the glycerol solution by electrodialysis; and, electrolytically splitting the salt component of the aqueous salt solution in a water splitting cell, thus producing a depleted salt solution, a recovered acid solution and a recovered base solution.

In an embodiment, the present disclosure provides a process for recovering and reusing a base catalyst and a neutralizing acid in biodiesel production, comprising transesterifying oil feedstock with at least one alcohol using a base catalyst, thus producing a biodiesel process stream and a glycerol-rich process stream comprising a salt; neutralizing the glycerol-rich process stream with an acid, thus producing a defatted glycerol-rich process stream and free fatty acids; subjecting the defatted glycerol-rich process stream to electrodialysis, thus separating an aqueous solution comprising the salt from the glycerol-rich process stream; placing the salt in the aqueous solution in a water splitting cell, thus converting the salt to the salt's acid and base components; and reusing the base component in the transesterifying reaction and reusing the acid component in the neutralizing reaction.

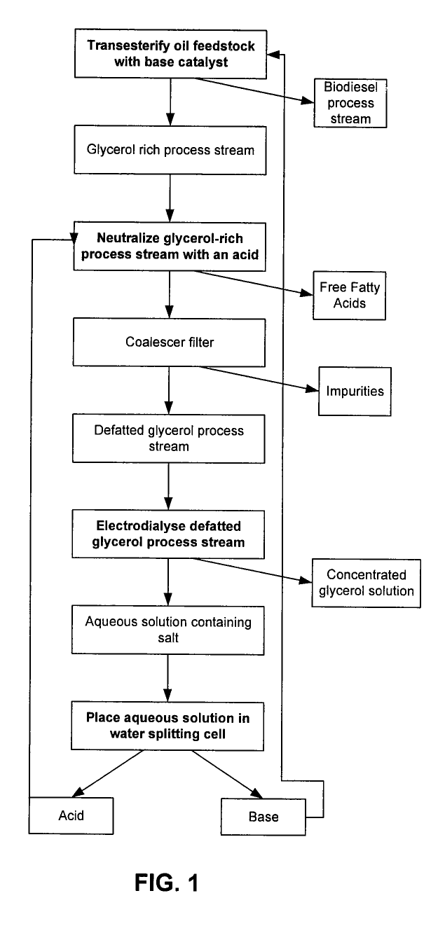

As illustrated in FIG. 1, the transesterification reaction between the oil feedstock and an alcohol using a base catalyst may produce a biodiesel process stream and a glycerol rich process stream. The glycerol process stream may contain fatty acid soaps in addition to glycerol. Suitable base catalysts include, but are not limited to, sodium hydroxide, potassium hydroxide, sodium methoxide, potassium methoxide, or a combination of thereof. According to embodiments of the present disclosure, the biodiesel process stream may be separated from the glycerol rich process stream and removed for further processing, if necessary. The glycerol rich process stream may then be combined with an acid in a neutralization reaction that converts at least some of the fatty acid soaps into insoluble free fatty acids.

As shown in FIG. 1, the free fatty acids are removed from the glycerol rich process stream, leaving a defatted glycerol-rich process stream, which also contains salt. In an embodiment, the salt that may be present in the glycerol process stream may be sodium chloride, potassium chloride, sodium sulfate, potassium sulfate or a combination of the salts. The defatted glycerol-rich process stream may be subjected to electrodialysis to remove the salt, resulting in an aqueous solution containing salt and a concentrated glycerol solution. As FIG. 1 indicates, the concentrated glycerol solution may be removed for further processing. The aqueous solution containing salt may then be placed in a water splitting cell, which converts the salt to its acid and base components. In the embodiment shown in FIG. 1, the recovered acid solution component may be recycled to the neutralization reaction and the recovered base component may be recycled to the transesterification reaction.

In an embodiment of the present disclosure, the transesterification reaction between the alcohol and oil feedstock may be carried out in a transesterification reaction vessel. Efficient mixing of the alcohol, oil feedstock and catalyst in the reaction vessel can be accomplished in a variety of ways, including by the use of an impeller attached to a motor. The motor rotates the impeller to agitate the mixture. If desired, the reaction can be carried out at room temperature, or elevated temperatures using a heating jacket, for example. The reaction can also be cooled, if necessary, by using a cooling jacket, for example. Separation of the biodiesel from the glycerol-rich solution can be achieved by allowing the reaction mixture to stand without agitation. The phases will separate out and can be removed from each other, for example, by draining the heavier glycerol-rich phase from the bottom of the reaction vessel, or skimming the biodiesel phase from the top. In an embodiment, the glycerol-rich process stream may be about 20-80% by weight glycerol. In further embodiments, the glycerol-rich process stream may be about 40-80% by weight glycerol.

The glycerol-rich phase also contains soluble fatty acid soaps, present because of the use of oil feedstock in the transesterification reaction. The glycerol-rich phase may be treated with a neutralizing acid to produce insoluble free fatty acids and a defatted glycerol process stream. What is meant by “acidify” is to add acid in any amount to a solution. In an embodiment, acid is added to a solution of soap in glycerol to convert any amount of the fatty acid soaps to free fatty acids. What is meant by “neutralize” is to add a sufficient quantity of acid to a solution comprising fatty acid soaps to convert greater than about 80% of the fatty acid soaps to free fatty acids. An example of a suitable neutralizing acid may be hydrochloric acid. This example is not intended to limit the disclosure as other suitable acids are known to one of skill in the art. The insoluble fatty acids are removed from the glycerol-rich phase by one of a variety of methods known in the art, such as centrifugation.

Prior to removal of the fatty acids, the glycerol-rich process stream may be optionally contacted with carbon and/or an ion exchange resin to remove organic contaminants. Suitable resins such as Optipore SD-2 (available from Dow Chemical Company, Midland, Mich.), Mitsubishi DCA11 (available from Itochu Resins, New York, N.Y.) or their equivalents can be used. The defatted glycerol rich process stream may also be treated with carbon and/or an ion exchange resin to remove organic contaminants.

The present disclosure also provides for desalting of the glycerol-rich process stream using electrodialysis. As noted above, the glycerol-rich process stream contains salt; the specific salt contained in the glycerol-rich process stream depends on the acid and base used in the above reactions. The electrodialysis apparatus is described in more detail below. Suitable electrodialysis apparatuses include, but are not limited to TS-2 (available from Ameridia, Somerset N.J.) or ELECTROMAT (available from (GE Ionics, Watertown, Mass.).

A concentrated glycerol solution and a aqueous salt solution are produced following electrodialysis. The recovered salt solution optionally may be treated to remove calcium and magnesium impurities, such as by passage through a chelating resin column or ion-exchange column, to yield a purified recovered salt solution. In an embodiment, the aqueous solution resulting from the electrodialysis step has a salt concentration of about 5-25% by weight. In additional embodiments, the aqueous solution has a salt concentration of about 10-20% by weight. The salt solution also may contain a small percentage of glycerol. For example, the aqueous solution may contain about 0%-10% glycerol. In further embodiments, the aqueous solution may contain about 0%-5% glycerol.

The aqueous salt solution may then be placed in a water splitting cell, described in more detail below, where the salt component may be converted to the salt's acid and base components. The conversion of the salt results in about 40-85% of the salt being converted to the salt's acid and base components. In further embodiments, about 50-80% of the salt may be converted to the salt's acid and base components.

The present disclosure further provides a process for desalting a glycerol solution containing fatty acid soaps and salt and converting the salt to the salt's acid and base components, comprising contacting the glycerol solution with an acid, thus producing insoluble free fatty acids removing the insoluble free fatty acids from the glycerol solution; placing the glycerol solution in an electrodialysis cell, thus separating an aqueous salt solution from the glycerol solution; and placing the aqueous salt solution in a water splitting cell, thus producing a depleted salt solution, a recovered acid solution and a recovered base solution. The insoluble free fatty acid layer produced in the neutralization reaction rises to the top of the glycerol-rich process stream and may then be separated, for example by centrifugation, to yield a defatted glycerol-rich process stream.

In an embodiment, the defatted glycerol-rich process stream may be treated to remove remaining free fatty acids. The defatted glycerol-rich process stream may be contacted with a coalescer membrane to remove remaining free fatty acids. In an embodiment, the defatted glycerol-rich process stream may be contacted with active carbon.

In an embodiment, the depleted salt solution may be recycled to an acid loop of the water splitting cell to further deplete the salt solution of salt. In an embodiment the salt solution may be depleted to a salt level determined based on the optimum operating conditions of the water splitting cell. The resulting acid solution may be used to neutralize fatty acid soaps in a glycerol-rich by-product phase.

Optionally, volatile components present in the glycerol-rich process stream or glycerol-rich defatted process stream are removed. Such volatile components include, but are not limited to, methanol, ethanol, fatty acid methyl esters and fatty acid ethyl esters. The alcohol components, for example, may be unreacted alcohol from the transesterification reaction. Volatile components can be removed by a variety of methods. For example, the glycerol-rich process stream can be placed in an extractive distillation column and subjected to distillation to separate the volatile components, such as unreacted alcohol, from the glycerol solution. The vapors from the extractive distillation, comprising unreacted alcohol, can be condensed and stored for further use.

In additional embodiments, the recovered acid solution may be contacted with a glycerol-rich process stream. The recovered acid is an acid solution that is produced from the water-splitting cell. Specifically, the aqueous salt solution that results from electrodialysis of the glycerol-rich process stream may be fed into the water splitting cell, where the acid and base components are recovered. The recovered acid can then be reused in the neutralization reaction.

In an embodiment of the present disclosure, the salt may be sodium chloride, the recovered acid solution may be a hydrochloric acid solution and the base product may be a sodium hydroxide solution. In an embodiment, the salt may be potassium chloride, the acid product may be hydrochloric acid and the base product may be potassium hydroxide.

In additional embodiments, the base solution recovered from the water splitting cell may be reused as a catalyst in the transesterification reaction. In a further embodiment of the present disclosure, the base solution recovered from the water splitting cell may be used as feedstock for production of sodium methoxide or sodium ethoxide. In an embodiment of such a process, one part of the recovered base solution may be mixed with four parts of an alcohol, such as methanol or ethanol, and distilled under reflux conditions to substantially remove all water formed from the reaction to produce a catalyst. The product containing sodium methoxide or sodium ethoxide may be recovered and the catalyst thus formed may then be used as a base catalyst in transesterification of fats or oils, for instance, in production of biodiesel.

In further embodiments, the disclosure provides a process for producing esters comprising combining an oil feedstock, an alcohol, and a homogeneous catalyst, thus producing an ester-rich phase and a glycerol-rich phase comprising fatty acid soaps; separating the ester-rich phase from the glycerol-rich phase; and contacting the glycerol-rich phase with a recovered acid solution, thus converting the fatty acid soaps to free fatty acids.

The disclosure further provides a process for producing esters, comprising combining an oil feedstock, an alcohol, and a homogeneous catalyst selected from a recovered acid solution, a recovered dewatered acid catalyst, a recovered base catalyst and combinations of any thereof.

In an embodiment of the present disclosure, the recovered acid solution, the recovered dewatered acid catalyst and the recovered base catalyst are produced using the methods of the present disclosure. A glycerol-rich process stream containing salt produced from the base and acid catalysts as a byproduct of a transesterification reaction as outlined herein is processed using electrodialysis to generate a salt solution, and the resulting salt solution can be processed into component acid and base in a water splitting cell, producing a recovered acid and a recovered base. The resulting recovered base solution is treated to remove water, yielding a base catalyst which is used in biodiesel manufacture. The resulting recovered acid solution is used to treat a glycerol-rich process stream to neutralize fatty acid soaps.

In an embodiment of the present invention, alkali and acid are recovered from a salt in a manufacturing process and are re-used in the process. A process for manufacturing fatty acid methyl esters such as biodiesel with the aid of a base catalyst generates a heavy phase enriched in glycerol and containing residual base catalyst and fatty acid soaps. After neutralization of residual base catalyst and fatty acid soaps with acid to form free fatty acids and salts of the base catalyst and acid, the salt is recovered and split into solutions of recovered base and recovered acid. After appropriate steps to adjust concentration, such as water removal, the recovered base is introduced in the transesterification of oil feedstock as base catalyst and the recovered acid is reused to treat a co-product of the biodiesel manufacturing process, contacting the recovered acid with a glycerol-rich process stream to neutralize residual catalyst (generating a salt such as NaCl) and split fatty acid soaps. In this embodiment, the base or the acid, or both, may be continuously re-used, providing significant cost reductions and reducing the need for purchase, storage, and transport of acid and base. This embodiment is illustrated in FIG. 1.

The invention also provides a biodiesel apparatus, comprising a biodiesel reactor; at least one electrodialysis apparatus fluidly connected to the biodiesel reactor; and at least one water splitting cell fluidly connected to the at least one electrodialysis apparatus, the biodiesel reactor, or both.

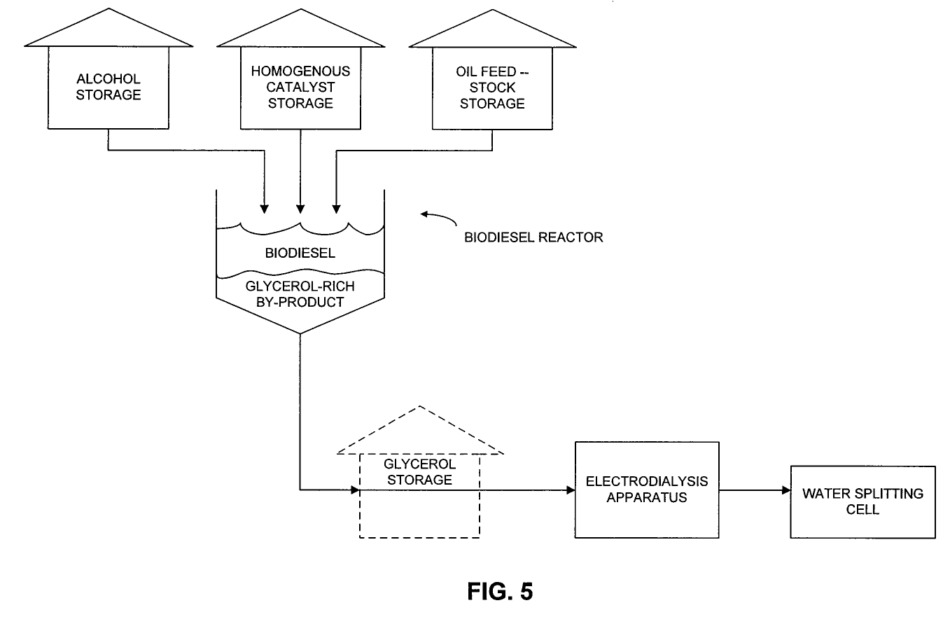

A schematic diagram of an example of an apparatus of the present invention is in FIG. 5. FIG. 5 illustrates that a biodiesel reactor, in an embodiment, is a vessel that is used to combine alcohol, a homogeneous catalyst and oil feedstock. The alcohol optionally can be combined with the homogeneous catalyst before placing the solution into the bioreactor with the oil feedstock. Likewise, the oil feedstock can be combined with either the alcohol or the homogeneous catalyst before adding the solutions to the bioreactor.

As noted in the embodiment depicted in FIG. 5, oil feedstock, alcohol and base catalyst are introduced into the reaction vessel from an alcohol storage tank and oil storage through the use of pumps or the tanks are gravity feed tanks. The alcohol is typically introduced in a ratio ranging from about 7% to about 40% by weight based on the oil used. Optionally, prior to introduction of alcohol into the reaction vessel, catalyst is mixed with the alcohol. The catalyst is typically used in amount ranging from about 0.1% to about 2.0% by weight based on the oil used. Reaction times depend on the temperature of the reaction, catalyst type and amount, and amount of alcohol.

In the present invention, fluidly connected to the biodiesel reactor may be an electrodialysis apparatus that, in the example illustrated in FIG. 5, is fluidly connected to a water splitting cell. Optionally, a glycerol storage tank can be connected to the biodiesel reactor which, in turn, may be connected to an electrodialysis apparatus. Thus, when two vessels are “fluidly connected,” fluid can be passed between the vessels, even if a intermediate vessel exists between the “fluidly connected” vessels, so long as the intermediate vessel is fluidly connected to the two vessels.

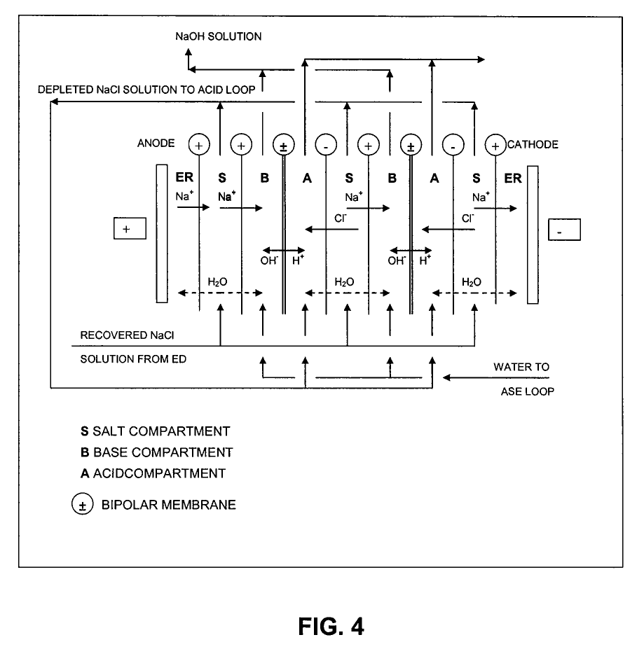

The recovered salt process stream is processed in a water splitting cell (WS), wherein the salt combines with cations and anions resulting from splitting of water (FIG. 4). In an embodiment, the water splitting cell has three compartments. Under a direct current driving force the H⁺ (hydrogen cations) and OH⁻ ions (hydroxy anions) generated at the bipolar membrane are transported to the acid and base compartments A and B, respectively, of FIG. 4. In an embodiment where sodium chloride is the salt, the Cl⁻ (chlorine anions) and Na⁺ ions (sodium cations) produced by the dissociation of salt (sodium chloride or NaCl) are transported across the anion and cation membranes, respectively. In the base compartment B of FIG. 4, the Na⁺ ions combine with the OH⁻ ions from split water to form the base product, sodium hydroxide. In a similar manner the Cl⁻ combine with the H⁺ ions from split water in the acid compartment A of FIG. 4 to form the acid product, hydrochloric acid. The net effect is the production of solutions or process streams of relatively pure acid (HCl) and base (NaOH) products from the salt (NaCl). The salt is thus converted to aqueous solutions or process streams of the constituent acid and base components, such as a hydrochloric acid solution or process stream and a sodium hydroxide solution or process stream, respectively.

In operation, for example, recovered salt solution is fed into each of the base compartments, the acid compartments, and the salt compartments of a water-splitting cell. Water is supplied to the base compartments. The water splitting cell has three effluent streams: a recovered acid solution from the acid compartments; a recovered alkali (base) solution, from the base compartments; and a depleted salt solution from the salt compartments. In an embodiment, the recovered acid solution comprises a hydrochloric acid solution. In an embodiment, the recovered alkali (base) solution comprises a sodium hydroxide (NaOH) solution. In an embodiment, the depleted salt solution from the WS cell is enriched in acid, and is used for treating a glycerol-rich phase or process stream from biodiesel synthesis to neutralize or partially neutralize alkali soaps of fatty acids, resulting in separation of free fatty acids in a decanting tank or centrifuge. In an embodiment, the recovered NaOH solution is suitable for concentration and use or reuse as a catalyst in biodiesel synthesis. In an embodiment, the recovered acid solution is suitable for use in the neutralization of the glycerol-rich phase generated in biodiesel synthesis. In an embodiment, any glycerol in the recovered salt solution remains in the salt loop of the cell and may be returned along with the acid to the upstream neutralization step.

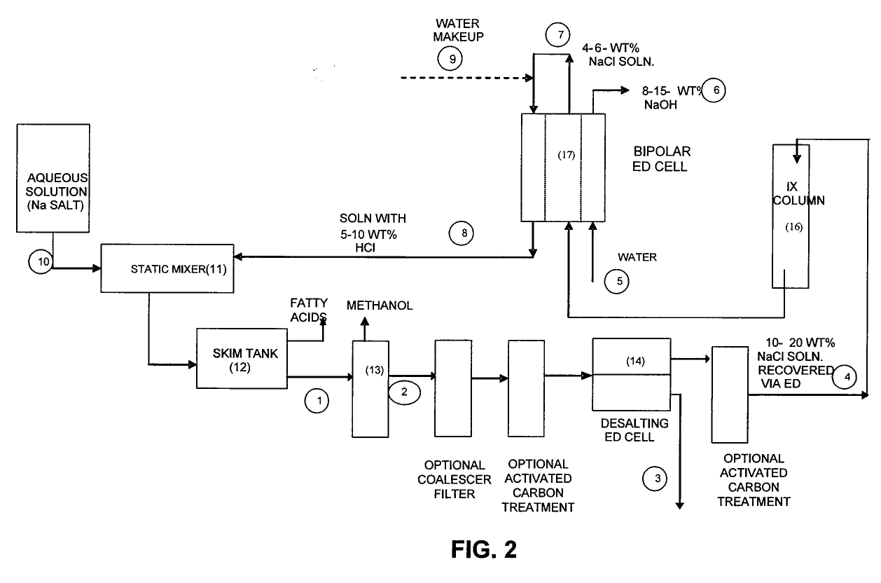

An additional embodiment is shown in FIG. 2. A glycerol-rich phase from biodiesel synthesis is neutralized with about 5-10-wt % hydrochloric acid (HCl) solution (generated downstream in a water-splitting cell) in a mixer tank (11). The sodium soaps of fatty acids in the glycerol-rich phase are converted to ions of Na+ and Cl−; the fatty acids resulting from the neutralization process float to the surface and are removed, for example in a decanting tank or by centrifugation (12).

The defatted glycerol-rich phase is removed from the bottom of the decanting tank and fed to a separator (13) to remove methanol, generating a crude glycerol solution containing 0.1 weight percent (wt. %) to 25 wt % salt. In an embodiment, the crude glycerol solution or process stream can be passed through a separating step to remove color bodies and other organic impurities, such as by passing through a bed of carbon, a coalescer filter, and/or ion exchange resin (not shown in FIG. 2). Suitable decolorizing resins such as Optipore SD-2 (available from Dow Chemical Company, Midland, Mich.) or Mitsubishi DCA11 (available from Itochu Resins, New York, N.Y.) can be used.

In the embodiment shown in FIG. 2, the crude glycerol solution is treated in an electrodialysis (ED) cell (14), generating a desalted glycerol solution (3) and a recovered salt solution (4). The recovered salt solution may contain a small amount of glycerol.

The recovered salt solution may be fed to a water-splitting cell (17). In an embodiment, the recovered salt solution may be passed through a separating step to remove color bodies and other organic impurities, such as by passing through a bed of carbon and/or ion exchange bed resin, before being fed to a water-splitting cell.

Referring to FIG. 2, recovered salt solution (4) from the desalting electrodialysis cell is further treated in an ion exchange column (16) to remove divalent cations and anions. The deionized stream is then combined with water (5) in the water-splitting cell (or bipolar electrodialysis cell (17)) and treated to yield a base stream (6), an acid stream (8) and a salt stream (7).

An example of an electrodialysis cell is depicted in FIG. 3. The cell comprises an alternating sequence of cation exchange membranes and anion exchange membranes assembled between a set of electrodes with void spaces between the membranes. In an electrolysis cell, under a direct current driving force the positive ions or cations move in the direction of the cathode, permeate selectively through the cation exchange membranes but are rejected by the anion exchange membranes, and accumulate in the void spaces on the anode sides of the anion exchange membranes. Similarly the negative ions or anions move in the direction of the anode, permeate selectively through the anion exchange membranes and are rejected by the cation exchange membrane and accumulate in the void spaces on the cathode sides of the cation exchange membranes. The membranes are separated from each other by void spaces created by thin gaskets. Due to the alternating arrangement of anion exchange membranes and cation exchange membranes, void spaces are either depleted of ions, or enriched in ions. Void spaces or compartments depleted of ions (or diluted) are labeled D in FIG. 3, and void spaces or compartments in which ions are concentrated are labeled C in FIG. 3. The compartments adjacent to the electrodes are called the rinse or electrode rinse (ER) compartments and are usually isolated from the cell unit by cation membranes. The input to and withdrawal of solutions from each of the compartments may be achieved through a set of manifolds and port channels in each of the gaskets.

An assembly comprising a cation membrane, a D compartment, anion membrane, and a C compartment is termed a “cell unit”. As many as 100-200 cell units may be assembled between a single set of electrodes and ER compartments, thereby forming a compact ED cell stack.

The separation process operates under a direct current driving force. When direct current is applied to the cell the cations (such as Na⁺) move from the dilute compartment D across the cation selective membrane (cation exchange membrane, indicated by a plus sign) toward the negative electrode (cathode, indicated by a minus sign), into the concentrating compartment C, and are retained there by the anion selective membrane (anion exchange membrane, indicated by a minus sign). Similarly the anions (Cl⁻) move from the dilute compartment D across the anion membrane toward the positive electrode (anode, indicated by a plus sign), into the concentrating compartment C, and are retained there by the cation selective membrane. The net result is the transport of ions from the D compartments into the C compartments, as shown in FIG. 3, forming salt solutions in the C cells. The extent of salt removal from the crude glycerol solution is dependent on the length of the desalting process and the current applied. Effluents from the ED cell comprise a recovered salt solution from the C compartments and a desalted glycerol solution from the D compartments; typical glycerol desalting levels are greater than 90 wt %. Recovered salt solution may be treated to remove water, yielding solid salts.

When a crude glycerol solution is treated by electrodialysis to remove salts, a certain amount of glycerol and water are also transported across the membranes with the ions and enter the C compartments. Water transport takes place when water associated with individual ions passes through the membrane. This water transport is beneficial in that water is removed from the glycerol in the D compartments, producing a desalted glycerol solution depleted in water. This in turn reduces the amount of water to be removed from the desalted glycerol solution, such as with an evaporator. In addition, transport of water into the C compartments permits the electrodialysis unit to operate in an overflow mode, obviating any need to add water to the recovered salt solution. In an embodiment, the concentration of salt in the recovered salt solution is 10 wt % to 20 wt %. The transport of glycerol into the C compartments is undesirable, as this results in loss of glycerol to the recovered salt solution. The amount of glycerol in the recovered salt solution (stream 4 in FIG. 2) varies with the membranes used in the ED cell, but is typically in the range of about 1-10 wt % or about 2-8-wt % of the glycerol in the crude glycerol solution fed to the electrodialysis cell.

In an embodiment, the recovered salt solution (Stream 4 of FIG. 2) is treated to remove calcium and magnesium impurities, such as by passage through a chelating resin column or ion-exchange column, to yield a purified recovered salt solution. An example resin is Amberlite IRC-747 (available from Rohm and Haas, Philadelphia, Pa.). The resulting purified recovered salt solution is fed to a water-splitting cell.

In the water-splitting cell, recovered salt solution or purified recovered salt solution is combined with water and treated to yield a base solution, an acid solution, and a depleted salt solution.

An example of a water-splitting cell is depicted in FIG. 4. A water-splitting cell is similar to an ED cell but each cell unit comprises three membranes and three void spaces (compartments). In addition to the cation and anion membranes found in an ED cell, each WS cell also contains a bipolar membrane. Bipolar membranes comprise a cation selective membrane layer and an anion selective membrane layer, the layers being joined together by a suitable low resistance interface. In a WS cell the membrane is oriented so that the cation selective side faces the cathode and the anion selective side faces the anode. When a direct current is applied across the bipolar membrane, any salt ions present between the cation selective membrane and the anion selective membrane quickly migrate out; the cations migrate across the cation layer toward the cathode and into the adjoining acid compartment (A) and the anions migrate across the anion layer toward the anode and into the adjoining base compartment (B). Consequently, any further electrical conduction across the bipolar membranes results from the diffusion transport of water molecules from the adjoining solution compartments to the membrane interface layer followed by the dissociation of the water molecules. When designed, constructed and operated properly the bipolar membrane is in effect a “water splitter” that forcibly dissociates the water molecules into hydrogen (H⁺) cations and hydroxyl (OH⁻) anions, and transports them under the electrical driving force to the adjacent solution compartments. The bipolar membrane in effect concentrates the H⁺ and OH⁻ ions from their concentration of 10⁻⁷ moles/l (pH 7) in water to a final concentration of 1 or more moles/l (pH 0 or 14) in the adjacent compartments. The minimum electrical potential for this operation is about ˜0.83V. Commercially available membranes typically operate at a potential of ˜1-1.2V at a current density of 100 mA/cm² for long time periods (one or more years).

As shown in FIG. 4 the cation membrane in the unit WS cell separates the salt compartment (S) from the base compartment (B), the bipolar membrane separates the acid (A) and base (B) compartments, and the anion membrane is located between the acid (A) and salt (S) compartment. In addition, ER cells adjacent to the electrodes are separated from the unit cells by a cation exchange membrane. Recovered salt solution or purified recovered salt solution is fed to the salt compartment and deionized water is fed to the base compartment.

When the recovered salt solution or purified recovered salt solution enters the void spaces of the WS cell, direct current is applied. Under a direct current driving force the salt ions from the recovered salt solution or purified recovered salt solution, such as Na+ and Cl− ions from the dissociation of NaCl, move selectively from the salt compartment across the cation and anion membranes to the base and acid compartments, respectively.

This results in a depletion of the salt concentration in the salt compartments. The depleted solution exits the salt compartment to form a depleted salt solution. Concurrently water molecules diffuse into the bipolar membrane from the adjacent compartments and are dissociated into H+ and OH− ions. These dissociated components, H+ and OH− ions, are transported to the acid and base compartments, respectively. The net result is the production of acid (HCl) and base (NaOH) solutions in the acid and base compartments, which then exit from their respective compartments as a recovered acid solution and a recovered base solution, respectively. In an embodiment, the depleted salt solution from the salt compartment is recycled to the entry side of the WS cell and fed to the acid compartments of the WS as shown. This is because in general for strong acids and bases the permselectivity of the anion membrane is lower than that of the cation membrane at a given normality. Consequently when a salt such as NaCl is processed in a three-compartment cell, the salt stream becomes acidic. Using the three compartment cell one can readily generate three useful product streams, namely NaOH, an acidified sodium chloride solution (brine) and HCl, all of which can be used in other process or recycled into an upstream processing step. Such mechanisms are described in K. N. Mani, “Electrodialysis Water Splitting Technology”, J. Membrane Sci., (1991), 58, 117-138, incorporated in entirety by reference.

The amount of salt converted in the WS cell and the concentration of the acid and base products recovered therein are governed by the characteristics of the membranes and the overall process economics. For example, conversion of salt to ions must be less than 100% or the conductivity of the solution will drop to an impractical level, and the solution resistance will increase with decreasing conductivity. The resulting high current density requirement to operate the cell would not be economical. Similarly, the concentrations of the acid and base produced are limited by diffusion and long-term membrane stability considerations. In an embodiment, about 40-85% of the salt is converted to acid and base components (such as HCl and NaOH). In an embodiment, the concentration of HCl in the recovered acid solution is about 5 wt % to about 10 wt %. In an embodiment, the concentration of NaOH in the recovered base solution is about 5 wt % to about 15 wt % (1-4 Normal).

In the WS cell a certain amount of water is transported as water of association out of the salt loop to the acid and base loops, and a stoichiometric amount of water is consumed in the conversion of water to H+ and OH− ions.

Referring again to FIG. 2, depleted salt solution (Stream 7) is recycled to the entry side of the WS cell and fed to the acid void spaced to facilitate removal of the acid generated in the acid loop as a recovered acid solution. Additional water (Stream 9) may be added to the acid loop in order to maintain the HCl concentration in the range of about 5 wt % to about 10 wt %. In an embodiment, the recovered acid solution (Stream 8 in FIG. 2) may be recycled to be mixed with a glycerol-rich phase resulting from biodiesel synthesis (Stream 10) to split fatty acid soaps and generate free fatty acids.

In an embodiment, substantially all of the glycerol in the recovered salt solution (Stream 4) is recovered in the depleted salt solution. As the depleted salt solution is recycled to the acid void spaces, the glycerol is contained in the recovered acid solution, and is returned with the recovered acid stream to the glycerol-rich phase or stream. Thus, the glycerol normally lost when using an ED cell alone is recovered and recycled to the process, eventually to exit the process in the desalted glycerol solution. In an embodiment, the overall glycerol recovery is 99.5% or greater; consequently, glycerol loss in the overall process is 0.5% or less.

In an embodiment, desalted glycerol solution from the ED cell (Stream 3 in FIG. 2) contains about 35 wt % to about 60 wt % glycerol. In yet another embodiment, the desalted glycerol stream may be subjected to additional purification and concentration steps to obtain a commercially marketable product.

The following non-limiting Examples are provided to further describe the invention. Those of ordinary skill in the art will appreciate that several variations these Examples are possible within the spirit of the invention.

### EXAMPLES

All ED and WS experiments were carried out using a laboratory ED unit containing 8 cells. The ED cell was assembled using AMT anion membranes and CMT cation membranes, both from Asahi Glass (Tokyo, Japan). The WS cell used BP-1E bipolar membranes and ACM anion membranes, both from Ameridia Corporation (Somerset, N.J.) and FKB cation membranes from Fumatech GmBH (St. Ingbert Germany). For electrical input the ED unit used a dimensionally stable anode (titanium substrate coated with a noble metal oxide) and a stainless steel cathode. The WS unit used a nickel anode and a stainless steel cathode. The gaskets used to create void spaces (solution compartments) were made from 40-mil thick low-density polyethylene sheet material. The gaskets, membranes and electrodes were assembled between two polypropylene end plates and the assembly was clamped together between two steel end plates using eight tie bolts. The effective area of the membrane (i.e. the active area of one membrane in a single cell unit) was ˜500 cm²; the total effective area of the 8 cell stack was 4,000 cm².

The assembled ED unit and WS unit were tested to ensure that there were no leaks between the various compartments (dilute, concentrate and the rinse compartments in the ED unit, and salt, acid, base and rinse compartments in the WS unit), and anchored in a process test skid. The skid had the requisite tanks, pumps valves, flow meters, etc. to circulate the fluids through the various compartments. The electrode rinse compartments for the ED unit and WS unit were supplied from a common tank. Direct current to the units was supplied from a regulated power supply. The examples were carried out at process stream and equipment temperatures of 28-40° C.

### Example 1

Oil feedstock was transesterified with methanol using a base catalyst in a process carried out substantially as described in U.S. Pat. No. 5,354,878 at ADM European Oleo Chemicals (Hamburg, Germany). Glycerol-rich phase containing glycerol, methanol, and fatty acid soaps resulting from this process was treated by evaporation of methanol, then by injecting hydrochloric acid and passing the mixture through a static mixer to a mixing tank. The acid was allowed to neutralize (acidify) the fatty acid soaps in the glycerol-rich phase, forming sodium chloride salt and free fatty acids, and the mixture was fluidly transferred to a settling chamber. Free fatty acids resulting from the neutralization step were separated by decanting, and a defatted glycerol-rich phase containing 80-85 wt % glycerol and 2.5 wt % NaCl was obtained. A quantity of defatted glycerol-rich phase was diluted with water to about 50 wt % glycerol. Seven liters of diluted defatted glycerol-rich phase was placed in the tank supplying the diluting compartments (D) of the ED unit. Four liters of water containing a small amount of sodium chloride salt was placed in the tank supplying the concentrate compartments (C) of the ED unit, and four liters of a ˜1.5-wt % sodium sulfate (Na₂SO₄) solution was placed in the tank supplying the electrode rinse compartments of the ED unit. The circulating pumps were turned on and the total flow to each of the loops was set at about 5 liters/minute. Electrodialysis of the defatted glycerol-rich process stream was carried out by activating DC power and setting the current at 10 A, representing a current density of ˜20 mA/cm². The total voltage across the ED unit was 10.1V at the start of the experiment. In this manner, desalting of defatted glycerol-rich solution was carried out for about forty minutes, generating a recovered salt solution (stream) and a desalted glycerol solution (stream). As the desalting operation progressed the voltage continued to increase until a set control value of 40V (representing ˜4.5V per cell for the eight cell unit, after allowing 4V for the electrode rinse compartments) was reached. At that point the voltage was kept constant and the current was allowed to fall. When the current input reached about 1.5 A (3 mA/cm² current density) the process was stopped. Electrodialysis of the defatted glycerol-rich stream through the ED unit in this manner yielded a desalted glycerol stream from which 99.3% of the salt had been removed. The recovered salt solution contained 44-gm/l of sodium chloride. The concentration of glycerol in the recovered salt solution was 12.3 gm/l; the amount of glycerol lost to the recovered salt solution was calculated to be ˜1.8% of the amount in the defatted glycerol-rich phase feed, representing a very small loss of glycerol.

### Example 2

Treatment of dilute defatted glycerol-rich phase was repeated five times substantially as in example 1, using 7 liters of defatted glycerol-rich phase for each trial. The recovered salt solution was reused in each trial, and the concentrations of salt and glycerol in the recovered salt solution and desalted glycerol solution, respectively, increased with each reuse. Salt removal in each of the trials was in the range of 98.8-99.4% and the glycerol losses in each trial were in the range of 1.5-2.9% of the amount in the feed. After the six trials the recovered salt solution contained 140 gm/l salt and 73 grams/liter of glycerol. The content of glycerol in the desalted glycerol solution increased from 49% by weight to 53% by weight due to removal of water from the glycerol feed tank.

### Example 3

The recovered salt solution obtained in example 2 was analyzed and found to contain 18.9 parts per million by weight (ppm/wt) calcium and 22.1 ppm/wt magnesium. These divalent ion contaminants in the solution were removed by passing the solution through a chelating resin ion exchange column to obtain a purified recovered salt stream (solution). A 600 ml column was used and the resin used therein was IRC-747 from Rohm and Haas. The purified recovered salt solution recovered from the column was free of calcium and contained 0.25-ppm/wt of magnesium. The salt and glycerol contents of the purified recovered salt solution were essentially unchanged after passage through the column.

### Example 4

The purified recovered salt solution from Experiment 3 (aqueous salt solution) was processed in a water-splitting (WS) cell installed in the test skid to split the salt into component acid and base and produce a recovered acid and a recovered base. A salt tank feeding the WS cell was loaded with 3-4 liters of purified recovered salt solution; an acid tank was loaded with 3-4 liters of a 5 wt % solution of hydrochloric acid; and a rinse tank for electrode rinse was loaded with 3-4 liters of a 5 wt % solution of sodium hydroxide. Three metering pumps were used to supply purified recovered salt solution from Example 3 to the salt tank and de-ionized water to the acid and base tanks at a controlled rate from their respective supply tanks. The pumps were started and the recycle flows to the cell were adjusted to ˜5 liters/min in each of the four loops. Electrolytic splitting of the salt component of the aqueous salt solution into component acid and base was initiated by activating DC power to the electrodes and the current was set at 45 A, representing a current density of 90 mA/cm². The total cell voltage was in the range of 18-24V, which translates to ˜1.75-2.5V/cell unit. Sufficient water was added to the acid and base tanks to produce a solution of recovered base exiting the WS cell containing about 12.5 wt % NaOH and a solution of recovered acid exiting the WS cell containing about 7 wt % HCl. Depleted salt solution was fed back to the input side of the acid compartments so that any glycerol trapped in the depleted salt solution could be recovered in the recovered acid solution; this is called a salt loop. Glycerol retention in the salt loop was about 93%, and about 96.5% in the salt loop and recovered acid solution combined. A mass balance calculation showed that the glycerol recovery in the combined ED-WS processes was >99.9%.

### Example 5

In a prophetic example, the recovered acid from the WS cell is recycled to be mixed with the glycerol-rich phase containing fatty acid soaps resulting from biodiesel manufacture, generating free fatty acids and a defatted glycerol-rich phase by splitting fatty acid soaps in a neutralization step (FIG. 1), obviating the need for fresh acid to be added to the glycerol-rich phase, with the additional benefit of obviating the need for disposal of the acid. The recovered base from the WS cell is dried to form a base catalyst and recycled to a transesterify oil feedstock with an alcohol in a fatty acid methyl ester synthesis process for use as a recovered homogeneous base catalyst, replacing fresh catalyst and obviating the need for neutralization of the alkali for disposal. When combined in this manner with an ester synthesis process, the combined ED-WS process will have essentially zero glycerol loss and zero salt effluent.

### Example 6

In a prophetic example, the recovered acid solution from the WS cell is used as a recovered catalyst to synthesize esters from free fatty acids and alcohols. The reaction mixture is treated to remove both water from the recovered acid solution and water generated in the ester synthesis reaction.

### Example 7

In a prophetic example, the recovered acid solution from the WS cell is treated to remove water and the recovered acid is used as a recovered dewatered acid catalyst to synthesize esters from free fatty acids and alcohols.

### Example 8

In a prophetic example, the recovered base solution from Example 4 is used as raw material for production of sodium methoxide or sodium ethoxide. One part of the base is mixed with 4 parts of methanol or ethanol and distilled under reflux conditions to substantially remove all water formed from the reaction. The product containing sodium methoxide in methanol (or sodium ethoxide in ethanol) is recovered from the distillation/stripping column. The catalyst so formed is then used in transesterification of fats or oils, for instance in production of biodiesel.

### Example 9

Oil feedstock was transesterified with methanol at ADM European Oleochemicals (Hamburg, Germany) using a base catalyst in a process carried out substantially as described in U.S. Pat. No. 5,354,878. A glycerol-rich heavy phase resulting from this process was obtained in the form of a dispersion. The glycerol-rich heavy phase dispersion contained glycerol, methanol, water and fatty acid soaps (3-6 wt %). The heavy phase dispersion was treated by injecting hydrochloric acid and passing the mixture through a static mixer to a mixing tank. The acid was allowed to acidify the fatty acid soaps in the glycerol-rich phase, forming sodium chloride salt and free fatty acids, and the mixture was fluidly transferred to a settling chamber. Free fatty acids resulting from the acidification step were partially separated by decanting, and a partially defatted glycerol-rich phase containing 30-40 wt % glycerol, 35-45 wt % water, 20-30 wt % methanol, 1.5-2.0 wt % sodium chloride and 0.3-0.6 wt % fatty acids was obtained. A solution of sodium hydroxide (NaOH) was added to the partially defatted glycerol-rich phase and the mixture was passed through a static mixer, then to a process for methanol evaporation. Methanol was separated by distillation, and a solvent-free glycerol-rich phase was obtained. The solvent-free glycerol-rich phase solution contained 40-50 wt % glycerol, 50-60 wt % water, 2.0-2.5% NaCl and 0.4-0.8% free fatty acids.

The solvent-free glycerol-rich phase solution was placed in a tank supplying the coalescer treatment for further reduction of the free fatty acids contained in the solution. About 250 liters of solvent-free glycerol-rich phase solution containing 0.52 wt % free fatty acids was fed to a coalescer membrane unit at 80° C. having a 5μ pore size coalescer membrane at a flow rate of about 100 liters/hour. In this manner, removal of free fatty acids (defatting) from the solvent-free glycerol-rich solution containing 0.52 wt % free fatty acids was carried out at 80° C. for about 2.5 hours, generating a recovered free fatty acid rich phase and a defatted glycerol-rich solution containing 0.041 wt % fatty acids. The defatted glycerol-rich solution was then subjected to a second coalescing treatment under the same process conditions to produce a glycerol-rich solution containing only 0.023 wt % free fatty acids. In total a 95.6% reduction of free fatty acids of the solvent-free glycerol-rich phase solution was achieved. The glycerol-rich phase solution was the subjected to active carbon filtration treatment to remove the remaining 0.023 wt % free fatty acids to yield a totally defatted glycerol-rich phase containing 40-50 wt % glycerol, 40-50 wt % water and 2.2% salt (NaCl). This mixture was then fluidly transported to electrodialysis for desalting.

What is claimed is:

1. A process for treating a glycerol solution containing fatty acid soaps comprising:
acidifying the glycerol solution with an acid to produce free fatty acids and salt;
removing the free fatty acids from the glycerol solution;
separating an aqueous salt solution from the glycerol solution by electrodialysis; and,
electrolytically splitting the salt component of the aqueous salt solution in a water splitting cell, thus producing a depleted salt solution, a recovered acid solution and a recovered base solution.

2. The process of claim 1, further comprising removing volatile components present in the glycerol solution, wherein the volatile components are selected from the group consisting of methanol, ethanol, water, fatty acid methyl esters and fatty acid ethyl esters.

3. The process of claim 1, further comprising contacting the recovered acid solution with a glycerol-rich process stream.

4. The process of claim 1, wherein the salt is sodium chloride, the recovered acid solution is a hydrochloric acid solution and the base product is a sodium hydroxide solution.

5. The process of claim 4, wherein the sodium hydroxide solution is used as feedstock for production of sodium methoxide or sodium ethoxide.

6. The process of claim 1, wherein the recovered base solution is used as a catalyst in biodiesel synthesis.

7. The process of claim 1, wherein the salt is potassium chloride, the acid product is hydrochloric acid and the base product is potassium hydroxide.

8. A process for producing esters comprising:
producing an ester-rich phase and a glycerol-rich phase comprising fatty acid soaps by combining an oil feedstock, an alcohol, and a homogeneous catalyst;
separating the ester-rich phase from the glycerol-rich phase; and
converting the fatty acid soaps to free fatty acids by contacting the glycerol-rich phase with a recovered acid solution.

9. The process of claim 8, wherein the recovered acid solution is recovered by treatment in a water-splitting cell.

10. The process of claim 8, wherein said homogeneous catalyst is selected from the group consisting of a recovered acid solution, a recovered dewatered acid catalyst, a recovered base catalyst and combinations of thereof.

11. A process for recovering and reusing a base catalyst and a neutralizing acid in biodiesel production, comprising:
transesterifying oil feedstock with at least one alcohol using a base catalyst, thus producing a biodiesel process stream and a glycerol-rich process stream comprising a fatty acid soap;
acidifying the glycerol-rich process stream with an acid to form a salt, thus producing free fatty acids and a defatted glycerol-rich process stream containing the salt;
electrodialyzing the defatted glycerol-rich process stream, thus separating an aqueous solution comprising the salt from the defatted glycerol-rich process stream;
splitting the salt into component acid and base in a water splitting cell, producing a recovered acid and a recovered base; and,
introducing the base in the transesterification of oil feedstock and contacting the acid with a glycerol-rich process stream.

12. The process of claim 11, wherein the salt is selected from the group consisting of sodium chloride, potassium chloride, sodium sulfate, potassium sulfate and a combination of any thereof.

13. The process of claim 11, wherein the acid is hydrochloric acid and the base is selected from the group consisting of sodium hydroxide, potassium hydroxide and a combination thereof.

14. The process of claim 11, further comprising contacting the glycerol-rich process stream, the defatted glycerol-rich process stream, or both, with carbon.

15. The process of claim 11, further comprising contacting the glycerol-rich process stream, the defatted glycerol-rich process stream, or both, with a decolorizing resin.

16. The process of claim 11, further comprising contacting the aqueous solution comprising the salt with a chelating resin.

17. The process of claim 16, wherein the chelating resin removes calcium and magnesium impurities.

18. The process of claim 15, wherein the resin is Optipore SD-2 or Mitsubishi DCA11.

19. The process of claim 6, wherein the resin is Amberlite IRC-747.

20. The process of claim 11, wherein the glycerol-rich process stream is about 20-80% by weight glycerol.

21. The process of claim 11, wherein the conversion of the salt results in about 40-85% of the salt being converted to the salt's acid and base components.

22. The process of claim 11, further comprising contacting the glycerol-rich process stream, the defatted glycerol-rich process stream, or both, with a coalescer membrane.

23. A biodiesel apparatus, comprising:
a biodiesel reactor;
at least one electrodialysis apparatus fluidly connected to the biodiesel reactor; and
at least one water splitting cell fluidly connected to the at least one electrodialysis apparatus, the biodiesel reactor, or both.
